(19) United States
(12) Patent Application Publication
(10) Pub. No.: US 2023/0110281 A1
(43) Pub. Date: Apr. 13, 2023

(54) PROCESS FOR PRODUCING COMPOUNDS OF INTEREST FROM AT LEAST ONE MINERALIZED CONNECTIVE TISSUE, AND COMPOUNDS OF INTEREST DERIVED FROM THIS PRODUCTION PROCESS

(71) Applicant: INSTITUT NATIONAL DE RECHERCHE POUR L'AGRICULTURE, L'ALIMENTATION ET L'ENVIRONNEMENT, Paris (FR)

(72) Inventor: Vincenza FERRARO, CLERMOND-FERRAND (FR)

(21) Appl. No.: 17/910,764

(22) PCT Filed: Mar. 10, 2021
(86) PCT No.: PCT/EP2021/056086

§ 371 Date: Sep. 9, 2022

(30) Foreign Application Priority Data
Mar. 11, 2020 (FR) FR2002416

(51) Int. Cl. A23J 3/04; A23J 1/04; A23J 1/10

(52) U.S. Cl. CPC A23J 3/04; A23J 1/04; A23J 1/10

(57) ABSTRACT

Disclosed is a method for manufacturing compounds of interest from at least one mineralized connective tissue, the compounds of interest including at least collagen. The manufacturing method includes a solid/liquid extraction step in which the at least one mineralized connective tissue is mixed with an eluent suitable for extracting the compounds of interest from the at least one mineralized connective tissue to the eluent. This extraction step includes successive operations of adjusting the pH of the eluent, separated by a time interval; each of which pH adjustment operations includes an addition of an acid in the mineralized connective tissue/eluent mixture, to reduce the pH of the eluent until reaching a pH value lower than or equal to 5.5, preferably lower than or equal to 4, preferably ranging from 2 to 4.

### TECHNICAL FIELD OF THE INVENTION

The present invention relates to the general field of the valorisation of the co-products that are generated by the animal agri-food industries.

In particular, it relates to methods for manufacturing compounds of interest from at least one mineralised connective tissue, said compounds of interest comprising at least collagen.

It also relates to products of biological interest, comprising the compounds of interest derived from these manufacturing methods.

### PRIOR ART

Animal industries generate many by-products and co-products, which are rich in compounds of industrial interest.

In particular, this is the case of biopolymers which have potential in many applications, including biomaterials and technical materials, biomedicine or textiles.

Among these biopolymers, collagen is particularly interesting because of its physical and biological properties.

Thus, there is a definite interest in extracting such compounds of interest, in particular collagen, from these by-products.

Thus, some methods consider a solid/liquid extraction of compounds of interest from mineralised connective tissues that are derived from the animal agri-food industry.

Solid/liquid extraction is a fundamental unit operation which aims to extract, separate, dissolve, either by immersion or by percolation, one or more components (liquid or solid) mixed with a solid.

Thus, this matter transfer or exchange operation is carried out between, on the one hand, a solid phase which contains the matter to be extracted and, on the other hand, a liquid phase, the extraction solvent (or eluent).

The methods reported in the prior art use an acid, often 0.5 M acetic acid, in combination with enzymes. These methods are conducted at a refrigeration temperature of 4° C. and with variable pH (increasing) throughout the extraction. The used volumes of eluent are variable, generally from 5 to 30 times the mass of the treated tissue.

For example, the document US2007/0219128 describes such a solid/liquid extraction method which is executed from fish bones immersed in water or an acidic solution. In this prior art, the acidic solution is added at the beginning of the extraction step, for immersion for 2 or 3 days, without any subsequent pH regulation.

But the current manufacturing methods are not completely satisfactory quantitatively (especially in terms of extraction yield) and/or qualitatively (the obtained collagen is often denatured or hydrolysed).

### DISCLOSURE OF THE INVENTION

In order to overcome the aforementioned drawback of the prior art, the present invention proposes a new a method for manufacturing compounds of interest from at least one mineralised connective tissue, said compounds of interest comprising at least collagen.

More particularly, the present invention relates to a manufacturing method which comprises the following steps:

a step of supplying said at least one mineralised connective tissue,

a solid/liquid extraction step, advantageously through a unique cycle, in which said at least one mineralised connective tissue is mixed with an eluent suitable for extracting said compounds of interest from said at least one mineralised connective tissue to said eluent,

a step of separating the eluent, containing said compounds of interest, from said at least one mineralised connective tissue,

an optional step of drying said compounds of interest.

And according to the invention, said extraction step comprises successive operations of adjusting the pH of said eluent, separated by a time interval.

Each of the pH adjustment operations comprises an addition of an acid in the mineralised connective tissue/eluent mixture, to reduce the pH of said eluent until reaching a pH value lower than or equal to 5.5, preferably lower than or equal to 4, preferably ranging from 2 to 4.

Indeed, the inventors have noticed that, without any intervention on the pH, the value of this parameter tends to increase throughout the extraction step.

Yet, the inventors then demonstrate that, surprisingly and unexpectedly, the adjustment of the pH (via successive adjustment operations) confers a significantly improved extraction yield, in the most natural way possible, in comparison with the known extraction processes (devoid of such pH adjustment operations).

Furthermore, the obtained collagen is very interesting from a quality perspective: the obtained collagen is non-denatured and/or non-hydrolysed.

In addition, the method according to the invention has the advantage of being able to be used on bones derived from adult bovine animals (over 5 years old). Indeed, the methods of the prior art are preferably applicable only on bones from young animals (less than 2 years old at slaughter) given the greater ease of extraction compared to an adult bone whose collagen is more cross-linked (the chemical availability of collagen being reduced due to age).

Other non-limiting and advantageous features of the method in accordance with the invention, considered individually or in any technically-feasible combination, are the following ones:

the pH adjustment operations are configured to maintain the pH of said eluent at a pH value lower than or equal to 5.5, preferably lower than or equal to 4, preferably ranging from 2 to 4;

the time interval between two pH adjustment operations is from one to five hours, preferably every 1 h30 to 2 h30;

the solid/liquid extraction step is carried out in the form of a unique cycle in which said at least one mineralised connective tissue is subjected to a unique solid/liquid extraction step, which at least one mineralised connective tissue is mixed with a determined amount of eluent which is completely introduced at the beginning of the solid/liquid extraction step, which solid/liquid extraction is advantageously implemented in a batch reactor;

during each pH adjustment operation, the pH of the eluent is measured, and, following each measurement, a suitable amount of acid is added so as to reduce the pH of the eluent to the predetermined target pH value;

during the solid/liquid extraction step, the temperature of the eluent is maintained at a value corresponding to the physiological temperature of the animal from which said at least one mineralised connective tissue is derived, for example 37° C., more or less 5° C.;

each of the pH adjustment operations comprises an addition of an acid selected from inorganic acids, for example hydrochloric acid;

the solid/liquid extraction step is carried out over a period of time of at least 5 days, for example ranging from 5 to 10 days;

during the solid/liquid extraction step, the mineralised connective tissue/eluant mass ratio is comprised within a range from 1/5 to 1/40 w/w, preferably from 1/15 to 1/25 w/w;

said at least one mineralised connective tissue is selected from mineralised connective tissues derived from mammals or fish, which mineralised connective tissues derived from mammals are advantageously selected from bones of cattle or pigs, preferably adult cattle over 5 years old, which mineralised connective tissues derived from fish are advantageously selected from bones and scales;

the solid/liquid extraction step is implemented under pseudo-static conditions or stirring conditions;

said eluent is devoid of enzymes, in particular proteolytic enzymes, and/or calcium chelating agents;

the supply step comprises an operation of physico-chemical preparation of said at least one mineralised connective tissue, which preparation operation comprises a mechanical treatment operation ensuring a reduction of said at least one mineralised connective tissue into powder, which powder advantageously has a particle size ranging from 0.5 to 2 mm;

initially, the eluent has an NaCl concentration lower than 60 g/L, preferably an NaCl concentration lower than 10 g/L, still preferably a value equal to 9 g/L;

the separation step is selected from among decantation, centrifugation or filtration;

the optional step of drying said compounds of interest is selected from among lyophilisation or atomisation.

The present invention also relates to the compounds of interest derived from the manufacturing method according to the invention, said compounds of interest comprising collagen and possibly proteoglycans and/or minerals and/or non-collagen proteins.

The present invention also relates to a product of biological interest, comprising the compounds of interest derived from the manufacturing method according to the invention, said compounds of interest comprising collagen and possibly proteoglycans and/or minerals, preferably from calcium, phosphorus and magnesium, and/or non-collagen proteins.

The present invention also relates to this product of biological interest for use thereof as a drug.

The present invention also relates to the use of a product of biological interest according to the invention, in an application selected from:

dietary supplement,

materials and biomaterials,

soil fertilisation.

Of course, the different features, variants and embodiments of the invention may be associated with each other according to various combinations to the extent that they are not incompatible or exclusive of each other.

### DETAILED DESCRIPTION OF THE INVENTION

In addition, various other features of the invention arise from the appended description made with reference to the drawings which illustrate non-limiting embodiments of the invention and where:

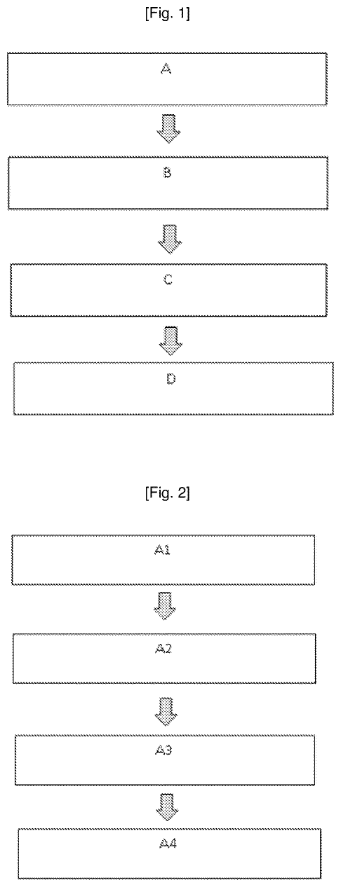

FIG. 1 is a block diagram which illustrates the main steps of the manufacturing method according to the invention;

FIG. 2 is a block diagram which illustrates an embodiment of the supply step;

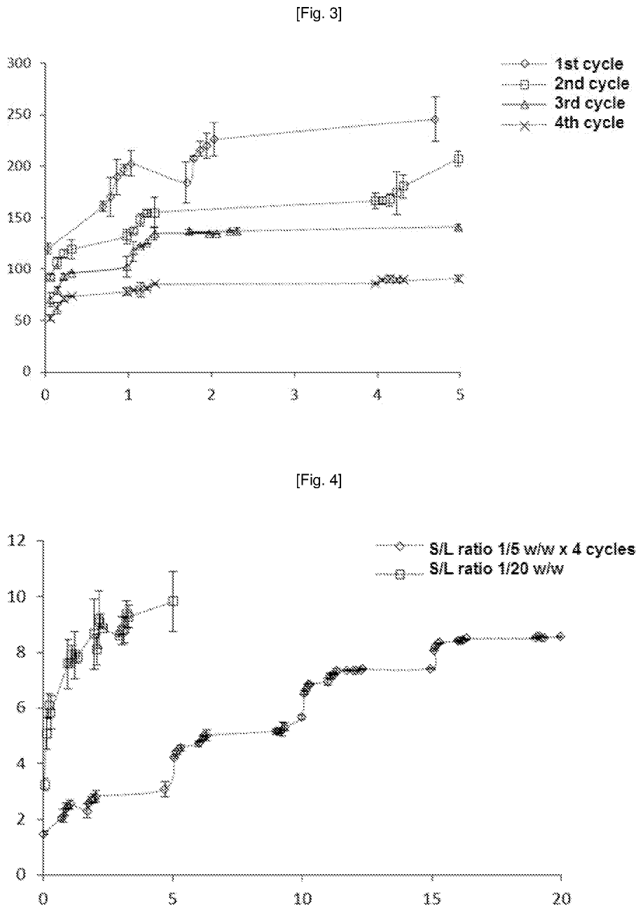

FIG. 3 is a graph representing the kinetics of collagen extraction by multi-cycle extraction (mean values and standard deviation bars), expressed in amount of collagen (mg) over time (day);

FIG. 4 is a graph representing the evolution of the total mass yields by multi-cycle (1/5 w/w) and single-cycle (1/20 w/w) collagen extraction (mean values and standard deviation bars), expressed in mass yield (mg of collagen per gram of bone) over time (day);

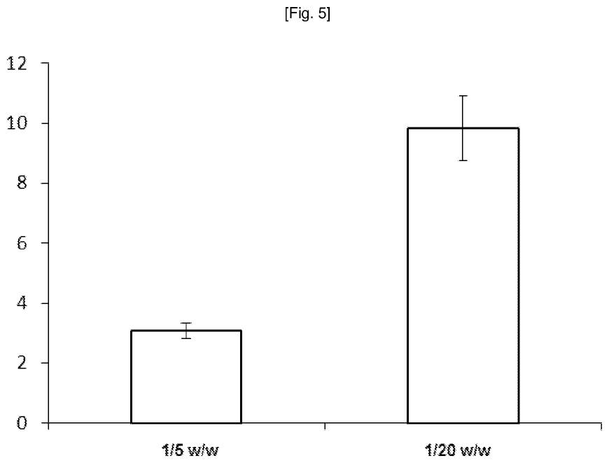

FIG. 5 is a diagram representing the mass yield of collagen (mg of collagen per gram of bone) at the end of the extraction (mean values and standard deviation bars), for the ratios 1/5 w/w and 1/20 w/w;

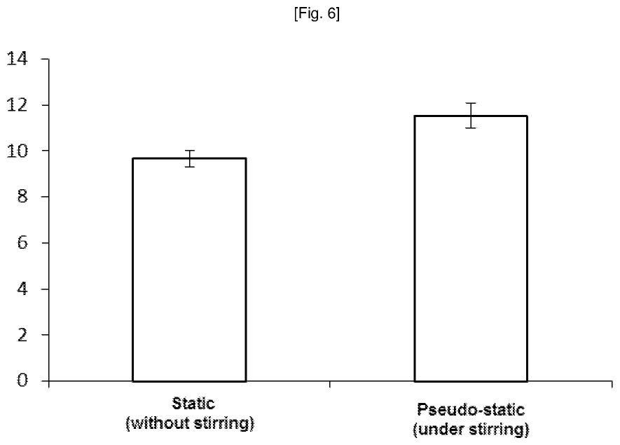

FIG. 6 is a diagram illustrating the mass yield of collagen (mg of collagen per gram of bone) as a function of the stirring regime (static—without stirring/pseudo-static—with stirring), at the end of the extraction (mean values and standard deviation bars);

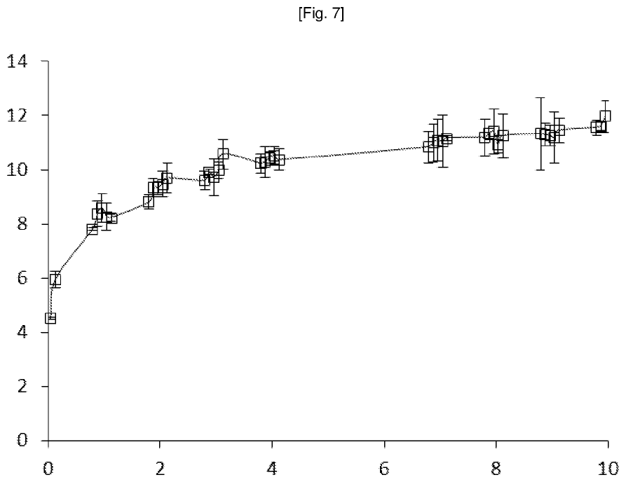

FIG. 7 is a curve showing the kinetics of collagen extraction (mean values and standard deviation bars) in mg of collagen/g bone, over time (days);

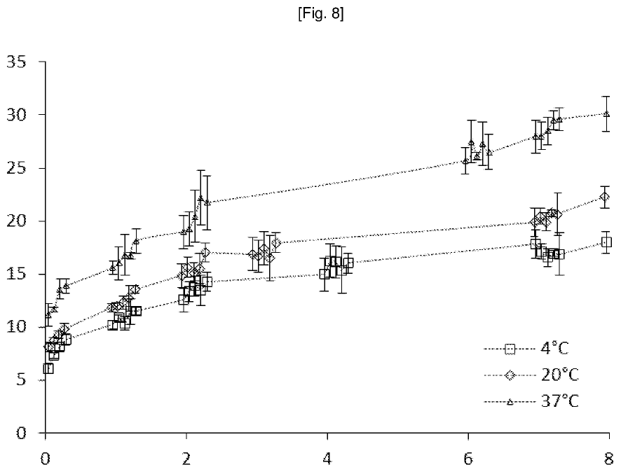

FIG. 8 is a graph which illustrates the effect of temperature on the collagen extraction yield (mg of collagen/g bone) over time (day);

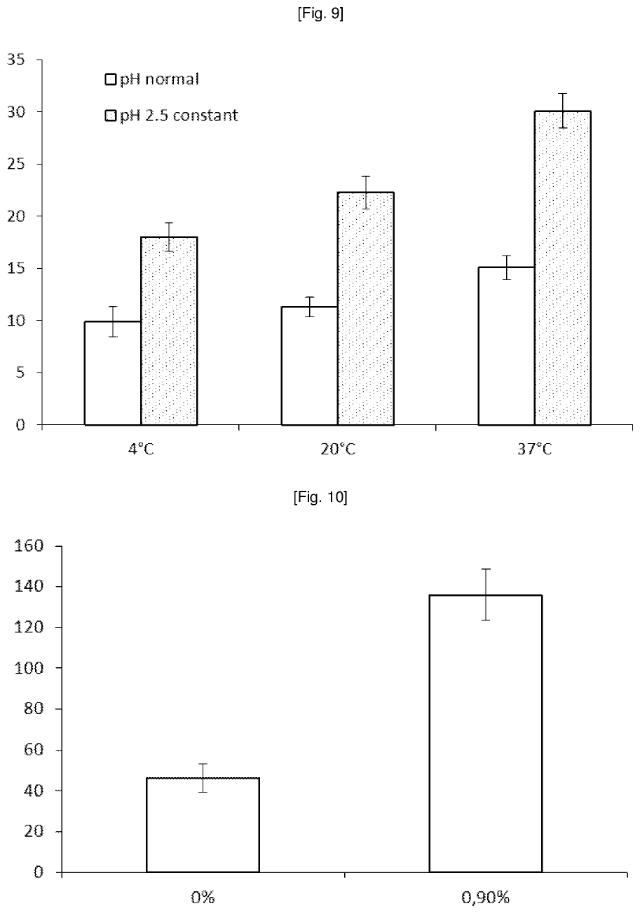

FIG. 9 is a diagram representing the effect of pH on the collagen yield (mg of collagen/g bone), with two managements of pH by temperature;

FIG. 10 is a diagram illustrating the glucose content (mg), with and without added NaCl (NaCl concentration w/w);

FIG. 11 is a diagram illustrating the effect of pH and temperature on glucose solubilisation, expressed in mg with two different pH values (normal and constant 2.5 ) for each temperature;

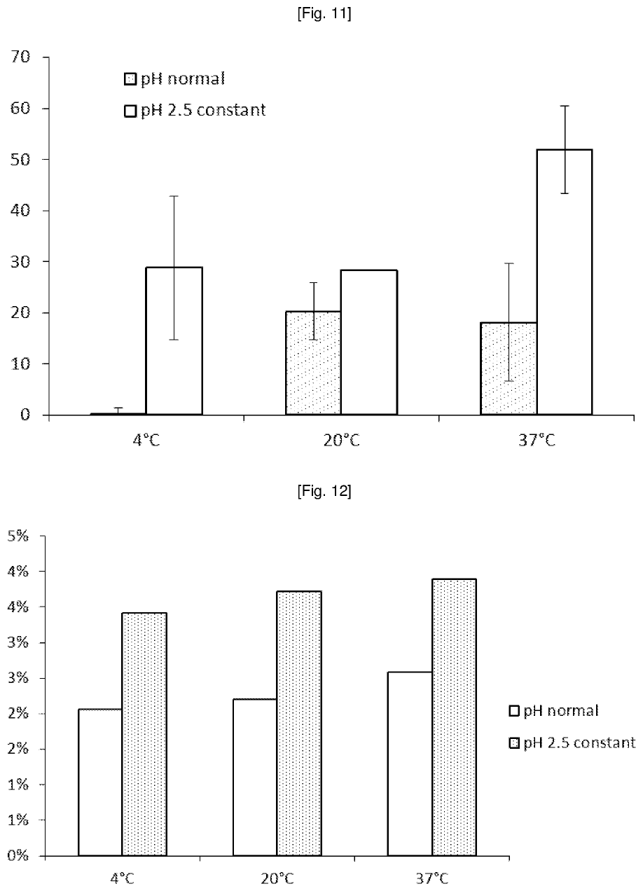

FIG. 12 is a diagram illustrating the effect of pH and temperature on dry matter, showing the percentage of dry matter with two managements of pH by temperature.

It should be noted that, in these figures, structural and/or functional elements common to the different variants may have the same references.

Thus, the present invention relates to a method for manufacturing compounds of interest from at least one mineralised connective tissue, and the compounds of interest derived from this method.

By “compounds of interest”, at least collagen is included.

In particular, collagen includes fibrillar collagens (FACIT), network-forming collagens, anchoring fibrils, transmembrane collagens, basement membrane collagens and others with unique functions.

Advantageously, members of the collagen family have a common characteristic: a straight triple helix composed of three a (alpha) chains. These may be formed by three identical chains (homotrimers), or by two or more different chains (heterotrimers), which are characteristic of humans and terrestrial animals.

Still advantageously, the collagen is selected from type I fibrillar collagen (characteristic of mineralised animal tissues it represents more than 90% of all collagens thereof).

The collagen may also possibly be selected from type II and V fibrillar collagen, basement membrane collagen (type IV), anchoring collagen (type VII), transmembrane collagen (type XVII) and FACIT collagen (Fibril Associated Collagen with Interrupted Triple helixes) (type XXII).

These different types of collagen are further described in the document of Gelse et al., 2003. “Collagens—structure, functions and biosynthesis”, Advanced Drug Delivery Reviews, 55, 1531-1546.

Advantageously, the collagen (derived from the method according to the invention) comprises at least one type I collagen.

Thus, the term “collagen” includes a single type of collagen or a mixture of at least two types of collagen.

Advantageously, the term “compounds of interest” also includes proteoglycans and/or minerals and/or non-collagen proteins.

Proteoglycans result from the combination of a protein and a glycosaminoglycan (GAG).

Advantageously, the proteoglycans consist of proteoglycans from the bone extracellular matrix, advantageously selected from among SLRPs (small leucine-rich proteoglycans) such as biglycan, decorin, mimecan, osteomodulin, and PRELPs (proline/arginine-rich repeat and leucine-rich repeat proteins).

Preferably, the minerals are selected from among calcium, phosphorus and magnesium.

Preferably, the non-collagen proteins include osteocalcin.

Manufacturing Method

For the manufacture of such compounds of interest, the method according to the invention comprises the following succession of steps (FIG. 1):

a step of supplying (A) said at least one mineralised connective tissue,

a solid/liquid extraction step (B) (also called “extraction step (B)”) during which said at least one mineralised connective tissue is mixed with an eluent suitable for extracting said at least one compound of interest,

a step (C) of separating the eluent, containing said compounds of interest, from said at least one mineralised connective tissue,

an optional step (D) of drying the compounds of interest.

Supply Step

Hence, the supply step (A) consists in supplying said at least one mineralised connective tissue (raw material) for treatment thereof by the solid/liquid extraction step (B).

By “mineralised connective tissue”, it should be understood in particular bone tissue, including reticular bone tissue, lamellar bone tissue and spongy bone tissue.

Advantageously, this mineralised connective tissue is selected from mineralised connective tissues derived from mammals or fish.

From mammals, the mineralised connective tissues are advantageously selected from the bones of cattle or pigs, in particular from adult animals over 5 years old.

The used bones are then preferably long bones, and more preferably the diaphysis portion of these long bones (obtained by removing the ends of the bone—epiphysis and metaphysis).

Advantageously, the long bones comprise the bones selected from: femur, clavicle, humerus, radius, ulna, metacarpals, phalanges, tibia, calf bone (or fibula).

In particular, cattle include bulls, oxen and cows.

Starting from fish, the mineralised connective tissues are advantageously selected from bones and scales.

For the extraction step (B), said at least one mineralised connective tissue is preferably subjected to at least one physico-chemical preparation operation.

Preferably, this preparation operation comprises a mechanical treatment operation to ensure a reduction of said at least one mineralised connective tissue into powder (also called “crushing and/or grinding”).

Advantageously, the mineralised connective tissue powder has a particle size distribution ranging from 0.5 to 2 mm (advantageously measured by a sieving method).

This preparation operation may also comprise, before grinding, operations selected from:

a cleaning/drying operation, for example by immersion in at least one alcohol bath (for example 70% ethanol),

a bone marrow removal operation.

Just for example, FIG. 2 illustrates a particular embodiment of this supply step (A) starting from long bone.

This particular embodiment comprises the following successive operations:

A1. an operation of removing the ends of the bone (epiphysis and metaphysis),

A2. an operation of slicing the diaphysis (middle portion of a long bone),

A3. an operation of washing the slices (in a 70% ethanol bath) and drying (at a temperature ranging from 40° C. to 50° C.), then

A4. an operation of removing the bone marrow, crushing and grinding the slices.

Thus, this embodiment generates a bone powder (in particular diaphysis), suitable for the next extraction step (B).

Extraction Step

The extraction step (B) consists of a solid/liquid extraction technique, also called “washing” or “leaching”, advantageously of the “maceration” type.

During this extraction step (B), said at least one mineralised connective tissue (solid phase) is mixed with an eluent (also called “solvent”, “extraction solvent” or “liquid phase”) which is suitable for extracting the compounds of interest from said at least one mineralised connective tissue to said eluent.

Advantageously, this extraction step (B) is carried out in the form of a unique cycle (also called “single-cycle extraction”).

In such a “unique cycle”, said at least one mineralised connective tissue is then subjected to a unique extraction step.

Said at least one mineralised connective tissue is then mixed with (immersed in) a determined amount of eluent which is completely introduced at the beginning of the extraction step (B).

This eluent, containing said at least one compound of interest, is recovered upon completion of the extraction step (B).

Advantageously, the eluent is a food grade/quality one (usable in human consumption).

Advantageously, the eluent consists of an aqueous solution which has an acid pH and which possibly contains NaCl.

More specifically, the eluent preferably consists of an acidic aqueous solution (also called “acidic medium”), the (initial) pH value of which is lower than or equal to 5.5, preferably lower than or equal to 4, preferably ranging from 2 to 4.

For example, this aqueous solution is selected from one of the following acids: formic acid, acetic acid, propionic acid, malonic acid, butyric acid, succinic acid, malic acid, citric acid, tartaric acid, lactic acid, phosphoric acid, hydrochloric acid, sulfuric acid, nitric acid.

Initially, the eluent has an NaCl concentration lower than 60 g/L, still preferably an NaCl concentration lower than 10 g/L, still preferably a value equal to 9 g/L (including a value approximately equal to 9 g/L, for example from 8.5 to 9.5 g/L).

Still advantageously, the eluent is devoid of enzymes and/or calcium chelating agents.

By “enzymes”, it should be understood in particular enzymes capable of degrading collagen, in particular proteolytic enzymes, namely for example metalloproteinases (collagenases, gelatinases), serine proteinases (elastase, cathepsin G), cystein proteinases (papain, calpains, cathepsins B, H, L, N and S), aspartic proteinases (pepsin, chymosin, cathepsins D and E).

For example, the calcium chelating agents include EDTA (ethylenediaminetetraacetic acid).

Preferably, the mineralised connective tissue/eluant mass ratio is comprised in a range from 1/5 to 1/40 w/w (weight/weight), preferably from 1/15 to 1/25 w/w (weight/weight).

Moreover, during this extraction step (B), the pH of the eluent is subjected to successive pH adjustment operations, which operations are separated by a time interval (two successive pH adjustment operations are thus separated from each other by a time frame).

More specifically, each pH adjustment operation comprises an addition of an acid in the mineralised connective tissue/eluent mixture.

Each addition is adjusted so as to obtain a decrease in the pH of the eluent until reaching a pH value (also called “predetermined target value”) lower than or equal to 5.5, preferably lower than or equal to 4, still preference ranging from 2 to 4.

In other words, the pH of the eluent is measured, advantageously on a regular basis; and, following each measurement, an appropriate amount of acid is added so as to reduce the pH of the eluent to the predetermined target value.

Still preferably, the pH adjustment operations are configured to maintain (advantageously continuously) the pH of the eluent at a pH value which is lower than or equal to 5.5, preferably lower than or equal to 4, preference ranging from 2 to 4.

In other words, these pH adjustment operations are adjusted so that, throughout the extraction step (B), the pH of the eluent has a value which is lower than or equal to a maximum threshold value of 5.5, preferably lower than or equal to 4, preferably ranging from 2 to 4.

This preferred operating mode (pH maintenance) is also referred to as “constant pH” (as opposed to a variable pH in the absence of regular control of the pH of the mixture during the extraction step (B)).

In this case, the time interval between two pH adjustment operations is advantageously from one to five hours, preferably from 1 h30 to 2 h30 (1 hour 30 to 2 hours 30).

Advantageously, each pH adjustment operation comprises the addition of an acid in the mixture, advantageously a 0.5 M acidic aqueous solution.

Advantageously, the acid is selected from among inorganic acids, for example: hydrochloric acid, phosphoric acid, sulfuric acid, nitric acid.

As illustrated in the example hereinafter, such successive pH adjustment operations allow for a significantly improved extraction yield in comparison with known extraction processes (without successive pH adjustment operations).

Still during this solid/liquid extraction step (B), the temperature of the eluent is advantageously maintained at a constant value, corresponding to the physiological temperature of the animal from which said at least one mineralised connective tissue is derived.

In practice, this temperature is advantageously adjusted to a value of 37° C., more or less 5° C.

Such a temperature ensures an interesting extraction yield, without any risk of denaturation of the extracted collagen.

Advantageously, the solid/liquid extraction step (B) is also implemented under conditions which are selected from:

pseudo-static conditions, for example with mixing for 15 to 20 minutes every 1 to 3 hours, or

stirring conditions, with mixing maintained throughout the extraction step.

Moreover, the extraction step (B) advantageously takes place over several days, preferably a period of time of at least 5 days, for example ranging from 5 to 10 days.

In practice, the extraction step (B) is advantageously implemented in a batch reactor (also called “batch”).

Thus, upon completion of this extraction step (B), the eluent forms a collagen solution, possibly still containing proteoglycans and/or minerals and/or non-collagen proteins.

Separation Step

Following the extraction step (B), the separation step (C) consists in separating the eluent (containing the compounds of interest) from the bone.

Advantageously, this separation step is selected from among techniques conventional per se, for example decantation, centrifugation or filtration.

By “decantation”, passive sedimentation is in particular considered following which the supernatant is recovered.

Drying Step

The optional drying step (D) consists in drying the compounds of interest, advantageously in elution in a low-acidic solution (for example pH of approximately 5.5), to obtain a soluble powder.

Advantageously, this drying operation (D) aims to eliminate the eluent through a phenomenon of evaporation and/or sublimation, so as to recover the compounds of interest.

For example, this optional drying step (D) is selected amongst freeze-drying or atomisation.

Lyophilisation (low-temperature operation) is performed after freezing of the eluent (for example at −30° C.), followed by sublimation of the same eluent at a pressure ranging from 0.1 and 5 mbar and at a temperature ranging from −30° C. to 15° C., for a duration ranging from 1.5 to 3 days.

For example, this operation allows obtaining a powder with 90 to 92% dry matter, 5 to 7% water and 1.5 to 4% acid.

The powder thus obtained advantageously features an assembly in the form of small-size microparticles (ranging from 0.5 to 20 micrometers in diameter) according to observation under a scanning electron microscope (magnification 7000×).

Atomisation (high-temperature drying) is performed on the eluent in its liquid state which is heated, for example to the temperature of 70° C., before passing through an addition which pulverises it and which introduces it into a drying chamber, the temperature of which is set for example at 150° C.

Afterwards, the powder is collected in a tank at room temperature. Advantageously, it has 95 to 96% dry matter, 3 to 3.5% water, 1 to 2% acid.

For example, the powder thus obtained features an assembly in the form of fibres whose diameter is advantageously of the same size range as the diameter of the collagen fibres in the bone (ranging from 0.05 to 2 micrometres) according to an observation under a scanning electron microscope (magnification 7000×).

Product of Biological Interest and Applications

Upon completion of the manufacturing method according to the invention, a product of biological interest is advantageously obtained which comprises the aforementioned compounds of interest.

Thus, this product of biological interest comprises at least collagen, and possibly proteoglycans and/or minerals and/or non-collagen proteins.

Advantageously, the obtained collagen consists of a natural collagen, which is advantageously neither fragmented nor denatured, thereby preserving its biological and mechanical properties.

For example, this collagen can be used to produce biomaterials and technical materials, or else as a source of nutrients for soils.

In addition to significantly increasing the collagen yield (3 times higher than the method of the prior art), this method according to the invention has the advantage of promoting the co-extraction of other molecules of biological interest, such as proteoglycans, and essential macro-elements such as calcium, phosphorus and magnesium, to preserve the primary structure (amino acid sequence of the alpha-helix) and the telopeptides characteristic of bone collagen (unlike conventional methods which use enzymes and which results in a loss of telopeptides and a partial hydrolysis of the protein chain).

Such a product of biological interest may also be considered in a therapeutic use, as a drug, for example to relieve inflammation due to osteoarthritis or rheumatoid arthritis, as a haemostatic, as an agent for regenerating connective tissues (bone, skin, tendons, ligaments), as an agent for healing wounds, as an antioxidant agent (collagen peptides, molecular weight lower than 3000 Daltons), and possibly as an agent for fighting type II diabetes, in particular thanks to the presence of the non-collagen protein (osteocalcin).

This product of biological interest can also be used in a non-therapeutic application, advantageously selected from among the following applications:

nutritious (food supplement),

cosmetics,

materials and biomaterials,

soil fertilisation.

Thus, the product of biological interest according to the invention can be incorporated into a cosmetic, pharmaceutical, food composition or a biomaterial.

The product of biological interest can be processed to form various oral preparations as drugs or health foods via methods well known per se. Examples of specific preparations include: tablets (including coated tablets, plain tablets, gastric suspension tablets, buccal tablets, effervescent tablets and chewable tablets), capsules (including soft capsules and microcapsules), granules, powdered preparations for infusion, effervescent granules, powders (including lyophilised powders), tablets (drops), controlled-release tablets (including enteric coated tablets, prolonged-release tablets), controlled-release capsules (including enteric coated capsules and prolonged-release tablets), fruit flavoured preparations, oral solutions, syrups, suspensions, aerosol preparations, solutions (including broth), gels, emulsions, suspensions, drops, etc.

In a pharmaceutical composition, the collagen of the product of biological interest according to the invention is advantageously used for the production of micro-particles, injectable dispersions, ophthalmic solutions, drug delivery systems, etc.

This application in the pharmaceutical and biomedical field is due to its characteristics such as low antigenicity, cell attachment capacity, biodegradability and biocompatibility.

The collagen of the product of biological interest according to the invention can also be used in the field of tissue creation. It can be used as a base matrix for cell culture systems and in tissue engineering such as injectable matrices, scaffolds for bone regeneration, etc.

Of course, various other modifications may be made to the invention within the scope of the appended claims.

### EXAMPLES

Solid-liquid extraction of bovine bone collagen

I. Material and Method

1. Bovine Bone

Bovine bones, of 5 different ages at slaughter, have been used for collagen extraction. All cattle were adult animals (more than 5 years of age).

The product has been ground and then stored at −20° C. until use.

The first step has been the study of the grain size distribution of the bone powders for the characterisation of the size of the particles.

For each age, the powder has been sieved through six different meshes, with dimensions of 0.2 mm, 0.4 mm, 0.8 mm, 1.0 mm, 1.4 mm and 2 mm. Afterwards, the studied particles of different sizes and ages have been mixed with an identical mass ratio.

2. Extraction of Collagen

Collagen has been extracted by solubilisation in an acid medium. A 0.5 M solution of food grade acetic acid has been used.

The extraction has been studied under different stirring regimes, as described hereinafter.

Furthermore, the extraction has been carried out at variable pH (increase in pH by the effect of collagen solubilisation) and at constant pH by the addition of acid.

2.1. Extraction of Collagen through Several Cycles (Multi-Cycle Extraction)

The extraction of the collagen has been carried out at a S/L (Solid/Liquid) ratio of 1/5 w/w (w=weight), i.e. 80 g of bone powder/400 g of eluent, acetic acid 0.5 M.

The tests have been carried out over a duration allowing reaching a plateau (no variation in concentration with increasing time).

During the extraction process, samples of the supernatant have been taken every 2 hours in order to determine the evolution of the collagen concentration over time.

At the end of each extraction cycle, the collagen solution (the supernatant) is recovered; a 0.5 M acetic acid solution is added to the residual bone to start a new extraction cycle of the same duration as the previous one, and with the same S/L ratio. Four consecutive cycles have been carried out.

2.2. Extraction of Collagen through One Cycle (Single-Cycle Extraction)

Single-cycle collagen extraction has been carried out in order to compare the yield versus the multi-cycle extraction.

The extraction of collagen is carried out at an S/L ratio of 1/20 w/w, i.e. 80 g of bone powder/1,600 g of 0.5 M acetic acid (i.e. the total mass of eluent that has been used for the four cycles of the multi-cycle extraction).

Samples of the supernatant have been taken every 2 hours in order to determine the concentration of collagen over time.

Several parameters have been taken into account in order to identify the conditions having an effect on the collagen extraction: the stirring regime, the temperature, the pH, the extraction duration, the addition of salt (sodium chloride, NaCl).

Influence of the Stirring Regime

To study the influence of this parameter, the extraction has been carried out in different regimes:

static regime, by stirring the solution for 30 seconds every 2 hours, and just before taking the samples, and

pseudo-static regime, by stirring the solution every 30 minutes for 30 seconds.

Influence of the Extraction Duration

In order to study the influence of the collagen extraction time, the collagen concentration has been determined every 2 h over several days and until reaching the maximum plateau (no variation in concentration over time).

Influence of Temperature

The extraction has been performed at different temperatures: in refrigeration at 4° C., at room temperature of 20° C. and at the bone physiological temperature of 37° C.

Influence of pH

The effect of pH on the collagen yield has been studied through a comparative experiment:

at normal pH, i.e. the pH of the supernatant during the extraction (without any intervention on the value of this pH), and

at constant acidic pH (constant pH 2.5 , using a 37% by weight HCl solution) throughout the process.

Influence of NaCl

The effect of NaCl on the solubility of collagen has been studied through two parallel experiments: NaCl at 0% and at 0.9% (w/w) (namely the physiological concentration in humans), added to the 0.5 M solution of acetic acid used for the extraction.

3. Quantification of the Compounds

Collagen has been quantified by UV-VIS (ultra-violet/visible) spectrophotometry and has been characterised by infrared spectroscopy, throughout which it is possible to verify the presence and the assembly of collagen, proteoglycans and minerals.

The collagen concentration has been determined by the BCA (BicinChoninic acid Assay) method, based on bicinchonic acid and on the Biuret reaction, calibrated on type I collagen from mouse bone (analytical control).

The eluent obtained at the end of the extraction has also been analysed via high-performance liquid chromatography (HPLC) in order to determine the amino acid level and the collagen concentration, in particular by the presence of hydroxyproline (unique amino acid of collagen).

The different types of collagen, proteoglycans and non-collagen proteins have been revealed via mass spectrometry (LC-MS/MS).

Total glucose (expressing the level of glycosaminoglycans in proteoglycans) has been quantified by the sulfuric acid method, implemented by Du Bois et al. (cf. Ferraro et al., (2017), Collagen type I from bovine bone. Effect of animal age, bone anatomy and drying methodology on extraction yield, self-assembly, thermal behaviour and electrokinetic potential, International Journal of Biological Macromolecules, 97, 55-66).

The dry matter has been estimated by drying in an oven at 105° C. for 16 h, according to the official method AOAC 968.08. For this purpose, 20 g of Fontainebleu sand have been deposited in a ceramic crucible and 20 g of the supernatant at the end of the extraction have been immediately added. After drying, the crucibles have been deposited in a desiccator to cool down before weighing. The percentage of dry matter has been calculated by dividing the amount of matter recovered after drying by the amount of matter before drying and by multiplying by 100.

The minerals in the eluent have been quantified by ion chromatography, and by X-ray energy dispersive spectroscopy (also called X-ray microanalysis) in the powders obtained after drying.

II. Results and Discussion

The obtained results have allowed highlighting that the collagen extraction is influenced by most of the studied parameters. But, among these parameters, surprisingly and unexpectedly, the management of the pH value seems to be decisive in the extraction yield.

1. Extraction of Collagen from Bone

According to the study of the particle size distribution, the results have shown that the weight average particle size is 1.2 mm; there is also a similarity in size between bone powders derived from different ages.

For each particle size, the powders of different ages have been mixed in equal proportion before extracting collagen.

1.1. Effect of the S/L (Solid/Liquid) Ratio and Multi-Cycle/Single-Cycle Effect

The use of two different S/L ratios (1/5 and 1/20 w/w) has allowed highlighting the impact of the amount of solvent with respect to the solid matter.

The result for the multi-cycle extraction, performed at the S/L ratio set at 1/5, is reported in FIG. 3.

After four successive cycles, an absence of growth in the collagen yield over time has been noticed; the curve of the kinetics of the 4th cycle actually has a slope close to zero and the additional amount of collagen obtained at the end of the extraction is close to zero.

On the other hand, as illustrated by FIGS. 4 and 5, the solid/liquid ratio of 1/20 w/w has allowed an extraction of a larger amount of collagen, that being so with a single cycle whose duration is identical to one of the cycles of the multi-cycle extraction (i.e. 5 days).

FIGS. 4 and 5 illustrate collagen yield by single-cycle and multi-cycle extraction.

Without being bound by any theory, by increasing the solid/liquid ratio, the saturation of the eluent is reduced and therefore the amount of collagen in solution, which is maintained in equilibrium with collagen in the bone powder, is increased.

Hence, the 1/20 (w/w) ratio has been maintained in the next steps.

1.2. Effect of Stirring

The results relating to the effect of stirring on the solubilisation of collagen are shown in FIG. 6.

The pseudo-static diet has allowed extracting more collagen (11.53 mg collagen/g bone) than the static diet (9.66 mg collagen/g bone) at normal pH.

Without being bound by any theory, a mechanical stirring of the particles in the solvent enables the homogenisation of the medium, a constant access of the solvent to the solid, and also provides an amount of energy that pushes the transfer of matter to the solid-liquid interface.

Consequently, the pseudo-static regime has been retained for the next experiments.

1.3. Effect of Extraction Duration

The evolution of the collagen extraction yield over time is reported in FIG. 7.

To study the effect of duration on the extraction step (stay time), a bone powder/solvent ratio of 1/20 (w/w) in pseudo-static regime has been used and the extraction has been carried on for 10 days.

In theory, the extraction time corresponds to the time necessary for the total recovery of collagen contained in the initial product.

The results show that the collagen extraction yields increases over time but that, as of the 8th day, a maximum plateau is reached.

Consequently, the 8-day duration has been chosen for the next experiments.

1.4. Effect of Temperature

The effects of temperature (at 4° C., 20° C. and 37° C.) have bee, studied with a bone powder/solvent ratio of 1/20 (w/w) in a pseudo-static regime, over a period of 8 days.

The results, shown in FIG. 8, prove that the yield increases with temperature.

Temperatures above 37° C., which is the physiological temperature, have not been used to avoid a risk of denaturation of the extracted collagen.

1.5. Effect of pH

pH management seems to confer a significant/determining effect on collagen solubilisation. The obtained yields, as a function of the pH, are reported in FIG. 9.

The results show that the yield is higher at “constant” pH 2.5 , regardless of the experimental temperature.

Thus, the yield evolves from about 18 mg of collagen/g bone up to 30.11 mg of collagen/g bone when the temperature varies from 4° C. to 37° C. at constant pH 2.5.

Yet, at “normal” pH (without any intervention on the pH value), this yield evolves from about 9.9 mg of collagen/g bone to 15.11 mg of collagen/g bone.

Thanks to the “constant” pH, advantageously in combination with an appropriate physiological temperature, an extracted collagen level of 30.11 mg collagen/g bone at pH 2.5 and 37 ° C. is therefore obtained, versus only 9.9 mg/g bone at normal pH and 4° C.

1.6. Effect of NaCl Concentration

The addition of NaCl (at the physiological concentration of 0.9% w/w) in the extraction solvent is not accompanied with any effect on the collagen yield.

2. Extraction of Glucose and Dry Matter

2.1. Glucose (Expressing the Level of Glycosaminoglycans in Proteoglycans)

The results show that the amount of solubilised glucose is dependent on the salt level, pH and temperature (FIGS. 10 and 11).

Like with collagen, the glucose level increases with, on the one hand, an increase in temperature and, on the other hand, a decrease in pH (FIG. 11).

NaCl herein has a positive effect on the solubilisation of glucose (FIG. 10).

The obtained amount of glucose is higher at constant pH 2.5 , for each of the experimental temperatures (FIG. 11).

2.2. Dry Matter Level

The results show that the amount of dry matter recovered at the end of the extraction varies with temperature and pH (FIG. 12).

This variation is in line with the results observed for collagen.

The results confirm that the solubilisation yield is higher at pH 2.5 for each of the experimental temperatures.

An increase in temperature promotes matter extraction.

The mineral matter represents from 60 to 65% of the dry matter, with 30 to 35% calcium, 8 to 15% phosphorus, 3 to 6% magnesium, the remainder being represented by mineral oxygen (bound to calcium and phosphorus).

Sodium (without added NaCl), chloride (without added NaCl), potassium and sulfur are present in the form of traces (less than 0.05%).

III. Conclusion

The influence of various parameters (pH management, extraction temperature, duration, stirring, etc.) has been studied on the extraction of collagen from animal bone.

The collagen extraction yield increases significantly thanks to a maintenance of the acidic pH of the S/L mixture, advantageously in combination with the increase in the temperature of the mixture and the duration of the extraction process.

1. A method for manufacturing compounds of interest from at least one mineralized connective tissue, said compounds of interest comprising at least collagen, which manufacturing method comprises:
a step of supplying said at least one mineralized connective tissue,
a solid/liquid extraction step, in which said at least one mineralized connective tissue is mixed with an eluent suitable for extracting said compounds of interest from said at least one mineralized connective tissue to said eluent,
a step of separating the eluent, containing said compounds of interest, from said at least one mineralized connective tissue,
wherein said solid/liquid extraction step comprises successive operations of adjusting the pH of said eluent, separated by a time interval,
each of which pH adjustment operations comprises an addition of an acid in the mineralized connective tissue/eluent mixture, to reduce the pH of said eluent until reaching a pH value lower than or equal to 5.5.

2. The manufacturing method according to claim 1, wherein the pH adjustment operations are configured to maintain the pH of said eluent at a pH value lower than or equal to 5.5.

3. The manufacturing method according to claim 1, wherein the time interval between two pH adjustment operations is from one to five hours.

4. The manufacturing method according to claim 1, wherein the solid/liquid extraction step is carried out in the form of a unique cycle in which said at least one mineralized connective tissue is subjected to a unique solid/liquid extraction step,
which at least one mineralized connective tissue is mixed with a determined amount of eluent which is completely introduced at the beginning of the solid/liquid extraction step.

5. The manufacturing method according to claim 1, wherein, during each pH adjustment operation, the pH of the eluent is measured, and, following each measurement, a suitable amount of acid is added so as to reduce the pH of the eluent to the predetermined target pH value.

6. The manufacturing method according to claim 1, wherein, during the solid/liquid extraction step, the temperature of the eluent is maintained at a value corresponding to the physiological temperature of the animal from which said at least one mineralized connective tissue is derived.

7. The manufacturing method according to claim 1, wherein each of the pH adjustment operations comprises an addition of an acid selected from inorganic acids.

8. The manufacturing method according to claim 1, wherein the solid/liquid extraction step is carried out over a period of time of at least 5 days.

9. The manufacturing method according to claim 1, wherein, during the solid/liquid extraction step, the mineralized connective tissue/eluant mass ratio is comprised within a range from 1/5 to 1/40 w/w.

10. The manufacturing method according to claim 1, wherein said at least one mineralized connective tissue is selected from mineralized connective tissues derived from mammals or fish mineralized mineralized.

11. The manufacturing method according to claim 1, wherein the solid/liquid extraction step is implemented under pseudo-static conditions or stirring conditions.

12. The manufacturing method according to claim 1, wherein the supply step comprises an operation of physico-chemical preparation of said at least one mineralized connective tissue, which preparation operation comprises a mechanical treatment operation ensuring a reduction of said at least one mineralized connective tissue into powder.

13. The manufacturing method according to claim 1, wherein, initially, the eluent has an NaCl concentration lower than 60 g/L.

14. Compounds of interest resulting from the manufacturing method according to claim 1, said compounds of interest comprising collagen.

15. A product of biological interest, comprising the compounds of interest derived from the manufacturing method according to claim 1, said compounds of interest comprising collagen.

16. The manufacturing method according to claim 1, wherein each of which pH adjustment operations comprises an addition of an acid in the mineralized connective tissue/eluent mixture, to reduce the pH of said eluent until reaching a pH value lower than or equal to 4.

17. The manufacturing method according to claim 1, wherein each of which pH adjustment operations comprises an addition of an acid in the mineralized connective tissue/eluent mixture, to reduce the pH of said eluent until reaching a pH value ranging from 2 to 4.

18. The manufacturing method according to claim 4, wherein the solid/liquid extraction is implemented in a batch reactor.

19. The manufacturing method according to claim 10, wherein said mineralized connective tissues derived from mammals are selected from bones of cattle or pigs.

20. The manufacturing method according to claim 19, wherein said mineralized connective tissues derived from mammals are selected from adult cattle over 5 years old.

21. The manufacturing method according to claim 10, wherein said mineralized connective tissues derived from fish are selected from bones and scales.

22. The manufacturing method according to claim 12, wherein the powder has a particle size ranging from 0.5 to 2 mm.

23. The method of claim 1, further comprising a step of drying the compounds of interest.
